(19) United States
(12) Patent Application Publication
(10) Pub. No.: US 2008/0175210 A1
(43) Pub. Date: Jul. 24, 2008

(54) Distributed spectrum analyzer

(75) Inventor: Jerel Scott Jamieson, Eagle, WI (US)

Correspondence Address: FOLEY & LARDNER LLP, 777 EAST WISCONSIN AVENUE, MILWAUKEE, WI, 53202-5306, US

(73) Assignee: Johnson Controls Technology Company

(21) Appl. No.: 11/657,203

(22) Filed: Jan. 24, 2007

(51) Int. Cl. H04Q 7/24

(52) U.S. Cl. 370/338

(57) ABSTRACT

A method of managing the radio frequency environment of a building zone includes using a plurality of radio frequency enabled building management devices distributed around the building zone. The method also includes interrupting a radio frequency enabled building management device from the device's primary building management function when a measuring event occurs, measuring radio frequency information of the building zone using the interrupted radio frequency enabled building management device, sending the measured radio frequency information from the radio frequency enabled building management device to a controller system, storing the measured radio frequency information in a database of the controller system. The method also includes repeating the interrupting, measuring, sending, and storing steps for a plurality of radio frequency enabled building management devices.

### FIELD

The present invention relates generally to the field of radio frequency management within building or area zones. In particular, the present invention relates to a distributed radio frequency spectrum analyzer utilizing radio frequency enabled building management devices distributed around a building zone to measure building zone radio frequency information.

### BACKGROUND

With the growing popularity of radio frequency and Wi-Fi enabled devices, radio frequency interference and congestion are also growing issues. Interference and congestion may render areas of a desired wireless zone unusable or unreliable for an intended purpose. This problem is especially relevant to wireless or partially wireless building management systems. Unlike many wireless networks wherein the wireless devices are mobile (laptops, etc.), wireless devices (such as temperature sensors or HVAC actuators) in a building management system are normally stationary. These stationary wireless devices of a building management system present unique challenges in heavy radio frequency interference environments.

The challenge of radio frequency interference in building management systems has been partially addressed by mesh network topologies wherein wireless devices (e.g., temperature sensors, etc.) may communicate with other wireless devices on the network to route information to or from the system controller along a number of alternative paths if the most direct path to the system controller is inoperable due to interference or another problematic condition. The mesh network topology is effective in providing redundant paths to aid in reliability of the network. For this reason, (and others, including cost) mesh or quasi-mesh topologies have become popular in the field of wireless building management systems.

While mesh topologies may increase reliability, they create several additional challenges in the context of building management systems. For example, wireless devices on a mesh building management network are often low-power wireless devices. Whereas interference issues of a traditional star topology network may often be addressed by increasing the power of the central wireless router, this is not an option when using a mesh network comprising a variety of low-power wireless devices. Additionally, because of the highly interconnected and node-dependent nature of a mesh network, it is desirable to conduct system-wide corrective maintenance (e.g., channel changing) during off hours.

The traditional way of dealing with interference in these mesh-based wireless building management systems is to detect and plan-around interference prior to installation and setup of the system. Dedicated spectrum analyzers may be used at this stage, but continued use of such devices may be impractical for building management as they are expensive, often require manual operation, and are technically difficult to use. Thus, while a building planner may use a dedicated spectrum analyzer to plan and install the wireless building management system, there is presently no efficient, effective, or inexpensive way to deal with interference on a continuing basis.

There is a need for a permanently installed and continually operating spectrum analyzer for wireless building management systems. Further, there is a need for a spectrum analyzer that may be distributed with low-power radio frequency enabled building management devices in a mesh network. Further, there is a need for a distributed radio frequency spectrum analyzer system that is configured to take regular measurements and output those measurements to a system controller or coordinator configured to store frequency, channel, and interference information, and wherein the system controller may select or assist in selection of the best operating parameters of the system.

It would be desirable to provide a system and/or method that provides one or more of these or other advantageous features. Other features and advantages will be made apparent from the present specification. The teachings disclosed herein extend to those embodiments that fall within the scope of the appended claims, regardless of whether they accomplish one or more of the aforementioned needs.

### SUMMARY

According to an exemplary embodiment, a method of managing the radio frequency environment of a building zone includes using a plurality of radio frequency enabled building management devices distributed around the building zone. The method also includes interrupting a radio frequency enabled building management device from the device's primary building management function when a measuring event occurs, measuring radio frequency information of the building zone using the interrupted radio frequency enabled building management device, sending the measured radio frequency information from the radio frequency enabled building management device to a controller system, storing the measured radio frequency information in a database of the controller system. The method also includes repeating the interrupting, measuring, sending, and storing steps for a plurality of radio frequency enabled building management devices.

A distributed spectrum analyzer for a building automation system includes a plurality of radio frequency enabled building management devices distributed around a building zone, each of the plurality of devices capable of measuring radio frequency information in the building zone. A distributed spectrum analyzer for a building automation system also includes a controller system configured to collect and analyze the measured radio frequency information, wherein the controller system maintains a database of collected measured radio frequency information.

Other features and advantages of the present application will become apparent to those skilled in the art from the following detailed description and accompanying FIGURES. It should be understood, however, that the detailed description and specific examples, while indicating preferred embodiments of the present invention, are given by way of illustration and not limitation. Many modifications and changes within the scope of the present invention may be made without departing from the spirit thereof, and the invention includes all such modifications.

### BRIEF DESCRIPTION OF THE FIGURES

The exemplary embodiment will hereafter be described with reference to the accompanying drawings, wherein like numerals depict like elements, and:

FIG. 1 is a perspective view of a distributed radio frequency spectrum analyzer installed in a building according to an exemplary embodiment;

FIG. 2 is a block diagram of a distributed radio frequency spectrum analyzer system according to an exemplary embodiment;

FIG. 3 is a block diagram of an exemplary embodiment of a radio frequency enabled device for use with a distributed radio frequency spectrum analyzer system;

FIG. 4 is a flow chart of an exemplary embodiment of the measurement operation of a radio frequency enabled device within a distributed radio frequency spectrum analyzer system;

FIG. 5 is a block diagram of an exemplary embodiment of a controller system and its operation within a distributed radio frequency spectrum analyzer system;

FIG. 6 is a flow chart of an exemplary embodiment of the operation of a controller system selecting the best channel based on data received from the distributed frequency spectrum analyzer system.

### DESCRIPTION OF THE EXEMPLARY EMBODIMENTS

In general, the system and method described herein for providing distributed radio frequency spectrum analysis includes the use of a plurality of wireless devices distributed over a zone, each of the plurality of devices capable of continually measuring radio frequency signal information in and around the zone, and a controller system configured to collect radio frequency signal information periodically output by the devices for the purpose of analyzing the radio frequency information in the zone. Using the collected measurement information, the controller system may develop a continually updating picture of the radio frequency environment of a building, thereby enabling the controller system or building management system to intelligently reconfigure the system or recommend intelligent reconfiguration. Using a plurality of low-power and multi-function or reduced function wireless devices well distributed around a building and configured in a mesh network, it is possible to create redundant, agile, and cost-effective building management system.

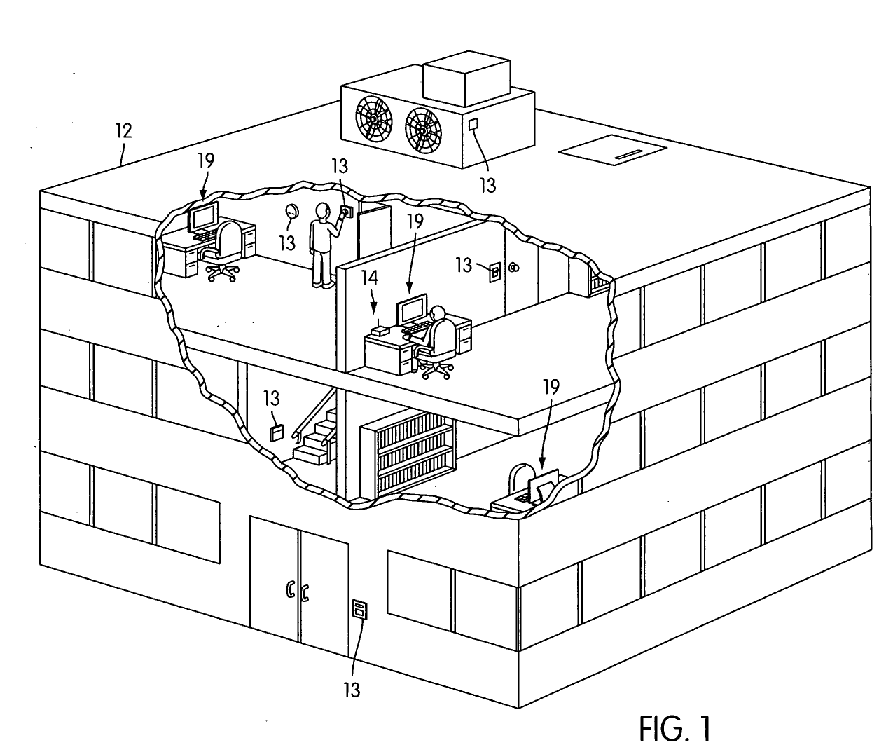

FIG. 1 is a perspective view of a building area 12 having a plurality of RF-enabled devices 13 capable of measuring the radio frequency (“RF”) environment of a building area or zone 12 according to an exemplary embodiment. As illustrated, building area 12 may include any number of floors, rooms, and/or other building structures. According to various exemplary embodiments, area 12 may be any area of any size or type, including an outdoor area. RF-enabled devices 13 may exist inside or outside the building, on walls or on desks, be user interactive or not, and may be any type of building management device. For example, RF-enabled devices 13 are illustrated as a security device, a light switch, a fan actuator, a temperature sensor, a thermostat, a smoke detector, etc. Controller system 14 is shown as a desktop wireless device. Workstation 19 is shown as a personal workstation. Generally, RF-enabled devices 13, in addition to conducting building management functions, may serve as RF measuring devices to measure RF environment of building area 12. Controller system 14 may serve as a network coordinator and/or recipient of the measurements conducted by the RF-enabled devices 13. Workstations 19 may allow building engineers to interact with the controller system 14.

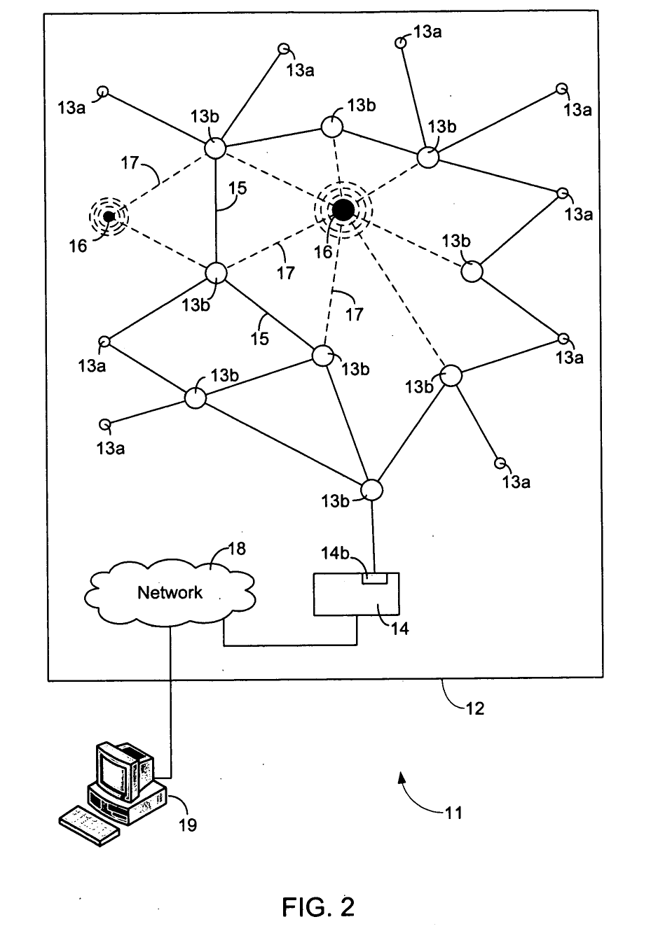

FIG. 2 is a block diagram of a distributed spectrum analyzer system (“DSAS”) 11 according to an exemplary embodiment. A DSAS 11 uses a plurality of RF-enabled devices 13 to measure the RF environment of a building area or zone 12. The RF-enabled devices 13 are communicably connected to a controller system 14. By distributing the plurality of RF-enabled devices 13 around the building area 12, the controller system 14 may conduct RF spectrum analysis on the entirety of building area 12. Furthermore, by having the RF-enabled devices 13 distributed around building area 12 conduct measurements on a regular basis, the controller system 14 may take corrective or preventative action itself or recommend such action to human building engineers. These actions may include a system-wide switch to a new channel, selection of various back-up frequencies or channels, selection of a set of operating frequencies within a multiple-channel system, investigation of RF interference detected along a particular building wall, sorting all available operating frequencies, etc. According to an exemplary embodiment, the DSAS 11 may be implemented as a mesh network in a commercial building environment. Other exemplary embodiments may include different wired or wireless technologies, different network topologies, and/or different environments, etc.

In the illustrated embodiment, the DSAS 11 includes a building area 12, a plurality of RF-enabled devices 13, a controller system 14, a network 18, and a workstation 19. The RF-enabled devices 13 are interconnected by RF connections 15 displayed as solid lines on FIG. 2. When a device conducts RF measurements, RF-enabled devices may drop connectivity with the network and enter a measuring or analyzing mode illustrated by RF-enabled devices 16. While RF-enabled devices 16 are in measuring or analyzing mode, their normal RF connection to adjacent RF-enabled devices 13 is disconnected and illustrated by temporarily disabled RF connections 17. A measuring or analyzing device 16 eventually stops measuring, sends measured RF information to a controller system 14, and resumes normal operation as an RF-enabled device 13 using now-operating RF connection 15. Controller system 14 collects and analyzes the measurement data sent from the plurality of RF-enabled devices 13 and received at controller system transceiver 14b. Controller system 14 may directly act on the data, or it may act in conjunction with a workstation 19, which may be connected to controller system 14 via a network 18.

In an exemplary embodiment, the plurality of RF-enabled devices 13 are small devices having low-power digital radio transceivers. In another exemplary embodiment, the RF-enabled devices 13 are ZigBee nodes. ZigBee is the name of a specification related to low cost and low power digital radios. The ZigBee specification describes a collection of high level communication protocols based on the IEEE 802.15.4 standard. A ZigBee node is a device generally conforming to ZigBee specifications and capable of existing or communicating with a ZigBee network. In other exemplary embodiments, the RF-enabled devices 13 could be any kind of radio frequency communicating wireless device including, but not limited to, Bluetooth devices and traditional 802.11 (Wi-Fi) based devices. In the exemplary embodiment displayed in FIG. 2, the RF-enabled devices 13 may be ZigBee nodes on a general-purpose, inexpensive, self-organizing, mesh network that can be used for industrial control, embedded sensing, medical data collection, smoke and intruder warning, building automation, home automation, etc. The resulting ZigBee mesh network will use very small amounts of power such that individual devices may run on a battery for an extended period of time. According to an exemplary embodiment, the RF-enabled devices 13 may consist of any type of ZigBee device including ZigBee coordinators, ZigBee routers, ZigBee end devices, etc. ZigBee coordinators and routers are generally RF-enabled devices that can act as intermediate routers and may pass data to and from other RF-enabled devices on the network. These devices are sometimes referred to as “full function” devices. Conversely, ZigBee end devices may not be able to relay data from other devices back onto the network. These devices are sometimes referred to as “reduced function” devices. As illustrated in FIG. 2, the DSAS 11 may include a number of RF-enabled devices that are either full function devices or reduced function devices. For example, RF-enabled devices 13a might be end devices or reduced function devices as they do not have more than one connection on the mesh network (i.e., they do not relay information from other nodes). According to an alternative embodiment, RF-enabled devices 13b might be coordinators or routers or full function devices that relay information to and from multiple RF-enabled nodes 13 on the DSAS 11 mesh network.

According to an exemplary embodiment, a plurality of RF-enabled devices 13 are RF-enabled building management devices. A RF-enabled building management device is an RF-enabled device 13 having at least one primary building management function. The primary building management function is often a building management sensor or actuator function (e.g., a temperature sensor, smoke detector, motion sensor, damper actuator, humidistat, etc.). A RF-enabled building management device 13 may have any number of secondary functions. For example, a secondary function is to serve as a RF-measuring device. Another secondary function may be to serve as a ZigBee relay on a mesh network. When the majority of RF-enabled devices have a primary building management function (i.e., are a RF-enabled building management devices), the DSAS 11 may be implemented at an especially low cost and made highly effective. In other words, when RF-enabled devices 13 have a primary building management function they do not constitute “extra” nodes on the network, but rather devices capable of both their primary building management function and a secondary RF measuring function.

Controller system 14 receives information from the plurality of RF-enabled devices 13. In an exemplary embodiment illustrated in FIG. 2, the controller system 14 forms the root of the RF network tree and might bridge to other network(s) 18. Controller system 14 is able to store or relay normal building management information about the RF-enabled devices 13 (e.g., temperature, smoke alarm, schedules, etc.) as well as RF spectrum information as measured by the RF-enabled devices 13. In the exemplary embodiment shown in FIG. 2, the controller system 14 is a ZigBee coordinator. In other exemplary embodiments, the controller system 14 might comprise multiple devices, computers, routers, or systems. In yet other embodiments, the measurement information might be forwarded or received at a system separate from that which receives normal building management information. For example, controller system 14 might forward the measured information to bridged network 18 for final arrival at a database on workstation 19. In other embodiments, workstation 19 may be a system that only accesses or displays data stored on system controller 14 via network 18. In other words, all systems involved in the control of the DSAS 11 may comprise the controller system 14.

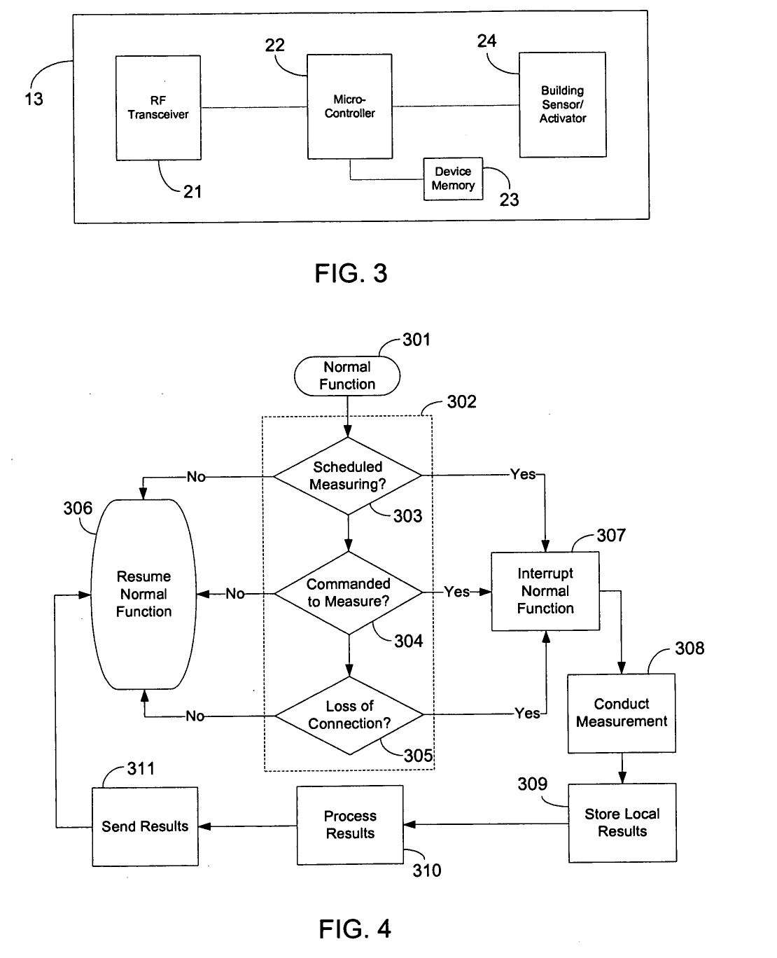

Referring to FIG. 3, in an exemplary embodiment, each RF-enabled device 13 includes an RF transceiver module 21, a micro-controller 22, a memory or storage portion 23, a building sensor/actuator 24. The RF transceiver module 21, the memory storage portion 23, and the building sensor/actuator are all operatively connected to micro-controller 22. In an exemplary embodiment, the RF transceiver module 21 is configured to both send and receive non-measurement building management information (e.g., relay information, information from the sensor/actuator) when operating in its usual or normal mode (i.e., when serving its primary building management function). When operating in its measuring mode, the RF transceiver module 21 is used to serve as a spectrum analyzer or measurement module. The information extracted by the RF transceiver module 21 while in measuring mode is measured radio frequency information. Measured radio frequency information is information regarding the radio frequency environment of the building zone and related to the purposes of a distributed spectrum analyzer system. Measured radio frequency information will normally not consist of radio frequency information received for the purpose of conducting regular network data communications. The measured radio frequency information extracted by the RF transceiver module 21 in measuring mode may include radio frequency signal to noise ratios, peak energy levels of channel samples, average energy over time, the nature of the measured energy (e.g., ZigBee related or not), the number of samples on each frequency, the average channel density, etc. When the RF-enabled device 13 has completed its measurement related duties, the RF transceiver module 21 may send measurement information and resume the transmission and reception of network-related commands. The measurement information sent from the transceiver 21 may include any information actually measured during the measuring mode, or information compiled or calculated by the micro-controller 22. Information measured by the RF transceiver 21 module may reside in the memory or storage portion 23 until a scheduled time for transfer or reporting. The building sensor/actuator 24 may comprise a variety of sensors or actuators configured for a variety of different building management functions. For example, the sensor/actuator may be a temperature sensor, a humidity sensor, a motion detector, a smoke detector, a damper actuator, or any number of other building-related modules. In alternative embodiments, the sensor/actuator may be external the housing of the RF-enabled device or not present at all. The DSAS 11 may be comprised of RF-enabled devices whose sole function is to measure RF information for spectrum analysis as well as devices having joint functions of RF measurement, RF transmittal and receiving, and primary building management functions.

In alternative embodiments, the RF-enabled devices 13 may have varying levels of autonomy from the rest of the DSAS 11. For example, in one embodiment, the RF-enabled device may simply take a few raw measurements at a time scheduled by the controller system 14. According to other various exemplary embodiments, the RF-enabled device may keep its own schedule, select particular measurements (e.g., measurements of varying sets of operating channels, measurements of possible backup channels, measurements of current channels, measurements of possible channels, re-checking measurements of previously detected bad channels, measurements of a single channel, measurements of any combination of multiple frequencies or channels, etc.), compile the measurement information in micro-controller 22 using memory storage portion 23 (e.g., use the measurement information of alternative channels to update a next-best system channel list in memory, etc.), and communicate only a conclusion or a single necessary piece of information (e.g., the cleanest alternative channel, a set of possible operating frequencies, etc.).

FIG. 4 illustrates a flow chart of one exemplary embodiment of a measuring process from a single RF-enabled device 13 of a DSAS 11. RF-enabled device 13 begins in normal function state (step 301). Normal function state generally includes conducting the RF-enabled device's normal sensing or actuating activities, sitting idle, sending or receiving sensing or actuating information, or serving as a network relay on a mesh network. At some regular time interval, the RF-enabled device will conduct a measuring event check (step 302). The measuring event check (step 302) may comprise any number of event checks that may send the RF-enabled device 13 into a measuring mode (step 307). For example, in one exemplary embodiment, the measuring event check (step 302) comprises a check as to whether a scheduled measuring is due (step 303), a check as to whether a command to measure has been received (step 304), and/or a check as to whether there has been a recent loss of network connection (step 305). If the measuring event check (step 302) is negative, the RF-enabled device 13 resumes normal function (step 306). If the measuring event check is positive, the RF-enabled device will interrupt normal function (step 307) and begin to conduct measurement (step 308). Measurement (step 308) may consist of any number of single or multiple measurements on any number of frequencies. For example, measurement (step 308) may consist of a single measurement of the current channel, a series of measurements of all channels, or any other measurement combination. According to an exemplary embodiment, measured results are stored locally (step 309), the RF-enabled device 13 processes the results (step 310) via micro-controller 22, and then sends the processed results (step 311) out via the transceiver 21 for eventual arrival at the controller system 14. When results have completed sending, the RF-enabled device 13 resumes normal function (step 306).

In an exemplary embodiment, processing (step 310) includes an algorithm wherein the RF-enabled device 13 conducts a series of calculations prior to sending (step 311). For example, the algorithm could be similar to a quasi-peak measurement calculation conducted in other spectrum analysis devices. The micro-controller 22 would generate a number representing the fraction of time available on each frequency and the level of interference. The quasi-peak aspect would prevent a low duty cycle source from causing rejection of that frequency. Weighing factors could be downloaded from the controller system 14 and could be optimized manually or automatically based on changing network conditions. These weighing factors might include a peak level of energy for each sample, the nature of the energy (e.g., whether ZigBee related or not), the number of samples on each frequency, etc. According to an exemplary embodiment, process results (step 310) could result in a weighted average channel energy density. The RF-enabled device could then send this number to the controller system (step 311) before resuming normal function (step 306).

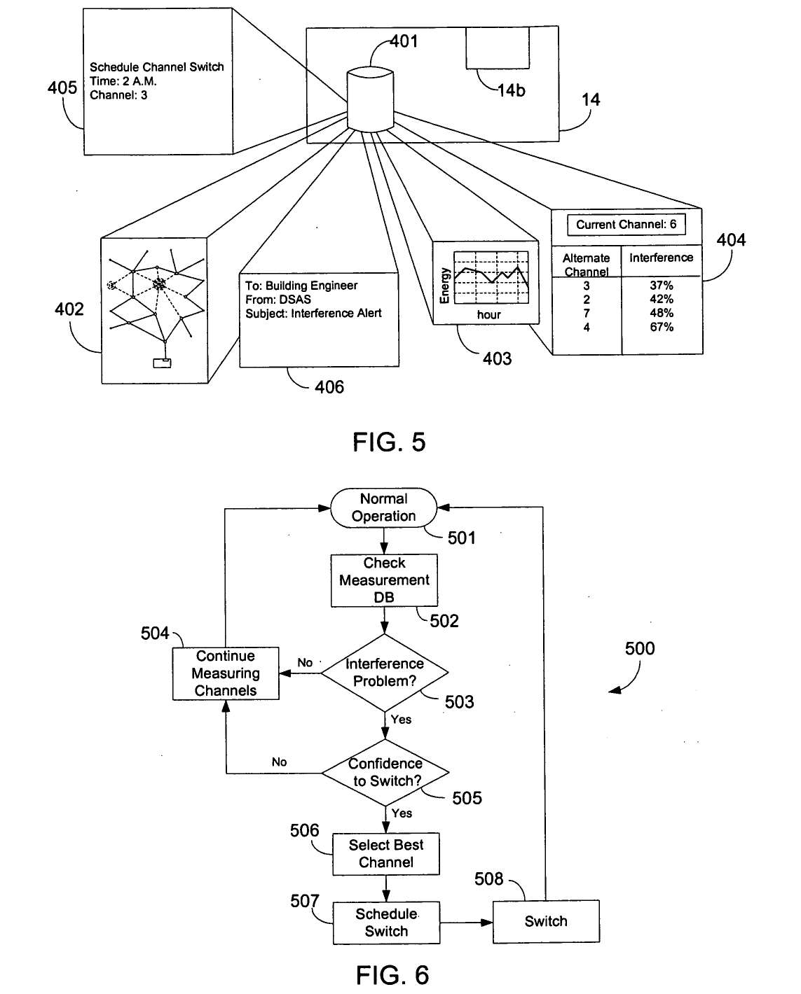

Referring to FIG. 5, in one exemplary embodiment, the controller system 14 may take any number of actions based on the RF measurement statistics generated by the DSAS 11. The exemplary embodiment displayed in FIG. 5 contains a variety of features a controller system 14 may have. As measurement information is received at the controller system's transceiver 14b, the controller system 14 may store the measurement information in a database 401. This database 401 may be manipulated to extract a variety of reports or take a variety of actions. For example, by identifying varying thresholds of unwanted (e.g., non-ZigBee) channel energy, a controller system 14 may establish varying warning levels of interference for each node (RF-enabled device 13) of the mesh network.

According to an exemplary embodiment, one way these levels of interference could be communicated to a human engineer is via a graphical user interface map 402. Map 402 may include a block diagram of the mesh network similar to FIG. 3 but the controller system 14 may color-code each node according to its measured level of interference. For example, nodes measuring a high level of interference may be colored red, medium levels may be colored yellow, and low levels of interference may be colored green. Using a map 402, a building engineer may instantly view a continually updated picture of the building's interference levels. This map could help the building engineer troubleshoot interference problems, move nodes away from interference, add nodes for increased redundancy in troubled areas, and/or assist in identifying foreign devices causing the interference.

According to another exemplary embodiment, interference could be communicated to a human via charts and graphs 403. The charts and graphs available may give a building engineer a way to “zoom into” each node (or groups of nodes) to view particular interference patterns. For example, graph 403 may include a plot of a node's signal to noise ratio by the hour. Using a signal to noise ratio plot, a building engineer may determine, for example, that while a device may experience high levels of interference for a short period during the day, the device normally experiences low levels of interference and that corrective action is not necessary.

According to an exemplary embodiment, tables of alternative system channels 404 may be continuously maintained by the controller system 14. The controller system 14 may average each potential channel's unwanted traffic across all RF-enabled devices and develop a table or list of alternative channels 404 sorted by channel availability or interference level. If a higher average interference level were to be detected on the current channel than on an alternative channel, the controller system 14 could schedule a system-wide changeover 405 to switch to the best alternative channel. A switch could be accomplished automatically without human intervention and without “channel searching” by each device, as these methods have proven to be cumbersome and inefficient. Moreover, using historical network activity data or sensing schedules, the system could intelligently pick the least disruptive or safest time to accomplish the changeover. For example, the system may be able to changeover between building employee shifts so that building population is as low as possible. According to alternative embodiments, the controller system 14 does not take action on its own, but simply warns building engineers by sending automated interference alert e-mails 406 so that building engineers can investigate using the controller system 14 tools.

According to an exemplary embodiment, DSAS 11 may be implemented in a multi-frequency wireless system whereby the RF-enabled devices 13 may be configured to conduct RF communications on multiple operating frequencies during normal operation. A multi-frequency system may operate with varying degrees of multiple frequency use (e.g., fast hopping, spread spectrum fast hopping, slow hopping, primarily single frequency with automated back-up channels, etc.). In other words, any single or multi-frequency system may benefit from the use of DSAS 11. For example, a frequency hopping system may transmit and scan across several frequencies during normal operation. For optimal performance, these frequencies must be selected carefully. According to an exemplary embodiment, the measurement data of DSAS 11 may be used to select a set of potential operating frequencies with various priorities for multi-frequency use. The measurement data of DSAS 11 may also be used to maintain a backup set of operating frequencies. According to an exemplary embodiment, the controller system 14 may send an updated set of operating frequencies to the various RF-enabled devices of the system on some regular interval. As in various other exemplary embodiments, when in measuring mode, RF-enabled devices 13 may measure any number of potential frequencies, including a large set of potential operating frequencies. As will be apparent to those familiar with the art of wireless communications, most structures or method steps that may apply to a single channel or frequency may also apply to multiple channels or frequencies. According to an exemplary embodiment, DSAS 11 may be implemented in any single or multiple frequency wireless system of the past, present, or future.

According to another exemplary embodiment, DSAS 11 may be implemented as a building zone radio energy management system capable of assisting a building engineer with the management of radio frequency energy of multiple wireless systems. For example, while the measuring may be conducted using a building automation wireless system, the RF-enabled devices 13 may be configured to measure radio frequency information of a building zone over a frequency range greater than the operating range of the device when the device is operating in its primary building management function. Measuring may include measuring the RF energy from two or more wireless systems. When operating in this manner, controller system 14 may present information to a building engineer that may allow him or her to view potential conflicts between two different wireless systems (e.g., a WiFi system and a building automation system, etc.) and may further allow him or her to use the controller system 14 to determine a course of action. Controller system 14 may alert a user when a potential conflict between two different wireless systems is detected (e.g., via a graphical user interface map, e-mail, pop-up window, report, etc.) and may subsequently recommend a course of action regarding the configuration of the two different wireless system. For example, controller system 14 may recommend that a WiFi access point be removed from one corner of a building; or controller system 14 may recommend that the building automation wireless system or the WiFi wireless system change channels. According to various other exemplary embodiments, controller system 14 may suggest any number of operating parameters for two different wireless systems located in or around the building zone based on the measured radio frequency information.

According to yet another exemplary embodiment, DSAS 11 may define radio frequency ranges or channel ranges in or around a building zone based on measured radio frequency information. These ranges may include low-energy ranges that a wireless system may work well with, high-energy ranges that may be considered “crowded,” ranges relating to specific different wireless systems (e.g., a WiFi system, a building automation wireless system, etc.), or any other range or set of ranges that may be useful to a building engineer. Controller system 14 may present the defined ranges to a user, use the defined ranges to suggest operating parameters for at least two wireless systems, use the defined ranges to suggest operating parameters for a single wireless system, develop an action strategy based upon the defined ranges, display a graph of the measured radio frequency information, and/or any other action discussed above with regard to channel changing or reporting to a user.

Referring to FIG. 6, a possible flow chart of one exemplary embodiment of a controller system 14 is shown. The majority of the time, controller system 14 will operate in a normal mode of operation (step 501) that will facilitate RF-enabled devices 13 and their primary building management functions. In a normal mode of operation, controller system 14 may also serve as a ZigBee coordinator, a file server, an overall building management system, a node on the mesh network, etc. According to an exemplary embodiment, an RF device management process 500 may run on the controller system 14. Process 500 may regularly check the measurement database (step 502). Process 500 may decide whether an interference problem 503 within the DSAS 11 exists. If an interference problem does not exist, the controller system 14 may continue measuring channels (step 504). According to various exemplary embodiments, the controller system 14 may take any number of channel measuring steps. For example, according to an exemplary embodiment, at continue measuring channels step (step 504), the controller system 14 may command the next scheduled RF-enabled device 13 to initiate the process illustrated by FIG. 4. That is, the controller system 14 may relay a command-to-measure signal to another RF-enabled device. According to an alternative embodiment, the controller system 14 may decide no measuring commands need to be issued and may simply continue normal operation (step 501). Multiple RF-enabled devices 13 may be issued measuring commands. In one exemplary embodiment, however, the controller system 14 will refrain from scheduling too many measuring events at one time so as to ensure the robust and redundant nature of the mesh network environment. If an interference problem is detected (step 503), the controller system 14 next asks whether it has confidence to switch the system channel (step 505). At this step, the controller system 14 may compare the current channel's interference level to the database of measurements to determine whether another channel will be significantly better. According to various exemplary embodiments, controller system 14 may conduct any number of confidence checks (step 505) relating to multiple channel operation (e.g., controller system 14 may decide whether to update a list of operating frequencies, backup frequencies, bad frequencies, single frequencies, and/or any other combination of actions that may require or benefit from confidence checking, etc.) Additionally, the controller system 14 may ask (in step 503 or 505) whether the current interference is trending to be a short-term problem or a long-term problem. If the problem appears to be short-term, the system may decide (step 503) that there is either no serious interference problem after all, or that the controller system 14 does not have confidence to switch the system channel due to a short-term problem. According to an exemplary embodiment, confidence check (step 505) may check to determine whether there are enough measurements to have confidence in an alternative channel. Confidence check (step 505) may importantly evaluate measurements conducted over a significantly long period of time so that a frequency or set of frequencies is not switched or selected based on temporal conditions. Because of confidence check (step 505), a channel switch or channel set selection conducted by DSAS 11 should be much more reliable and sure than a switch or selection based on a burst transmission or short term spectrum measurement.

If the system decides that an alternative operating parameter (e.g., operating channel, backup channel, alternative channel set, frequency ranges, channel priorities, etc.) is significantly better than the current operating parameter and that the system has confidence to in the new operating parameter, the controller system 14 may conduct an operating parameter selection process (step 506) (e.g., a channel selection process 506, etc.). For example, channel selection process (step 506) may conduct a detailed comparison of the top three alternative channels in the measurement database to determine which might provide the best fit for the building environment of the DSAS 11. While the channel with the lowest overall interference average may appear to be the best alternative channel, another channel may experience less interference volatility during the business hours of the building 12. Channel selection process (step 506) may be as simple as selecting the channel that the controller system 14 has pre-determined to be the best alternative channel. The distributed and permanent nature of this system allows alternative operating parameters to be researched and selected in advance of any network problem.

According to an exemplary embodiment, once a channel has been selected for switching (step 506), the controller system 14 may schedule a system-wide channel switch (step 507). The scheduling decision (step 507) may consider the traffic patterns of the mesh network and select the least disruptive time to conduct the network switch. For example, during high traffic periods of the day in the building area 12, it may be undesirable to attempt a channel change. Moreover, if the building management system is heating or cooling the building in the morning after maintaining a nighttime temperature, it may not be desirable to interrupt the sensors and actuators of the network during this time. However, depending on the seriousness of the DSAS 11 system interference problem, the controller system 14 may decide during scheduling (step 507) that an immediate channel switch 508 is merited. In an exemplary embodiment, the controller system 14 may send alerts to human building engineers prior to taking action. Any channel switch (step 508) may be overridden by human intervention. Additionally, if no single channel is desirable for the network, the controller system 14 may assist a human building engineer in deciding where to split the network or to add additional relaying devices by consulting the maps and reports illustrated in FIG. 6.

According to an exemplary embodiment, interference problem check (step 503) may consist of any number of questions for determining when to take action. Interference problem check (Step 503) may generally check to determine whether any action event has occurred. These action events need not be limited to interference or measurement. For example, if the system experiences a threshold number of failed transmissions on the network, the controller system 14 may determine that an action event has occurred (at step 503) and that corrective action (such as a channel change) is necessary.

It should be noted that throughout this application terms relating to the words radio frequency (e.g., “RF-enabled devices 13,” “radio frequency,” “RF,” etc.) may refer to any number of frequency bands or technologies according to various exemplary embodiments. For example, DSAS 11 and its components may operate on any frequency or set of multiple frequencies of the electromagnetic spectrum that may enable wireless communications. According to various exemplary embodiments the wireless devices (e.g., RF-enabled devices 13, controller system 14, etc.) may be devices configured to communicate on any frequency from extremely low frequency (e.g., 3-30 hz, etc.) to extremely high frequency and beyond (e.g., 300 Ghz+, etc.). For example, DSAS 11 may be implemented in an extremely low frequency range (e.g., 3-30 hz, etc.), a super low frequency range (e.g., 30-300 hz, etc.), an ultra low frequency range (e.g., 300-3,000 hz, etc.), a very low frequency range (e.g., 3-30 khz, etc.), a low frequency range (e.g., 30-300 khz, etc.), a medium frequency range (e.g., 300-3,000 khz, etc.), a high frequency range (e.g., 3-30 mhz, etc.), a very high frequency range (e.g., 30-300 mhz, etc.), an ultra high frequency range (e.g., 300-3,000 mhz, etc.), a super high frequency range (e.g., 3-30 ghz, etc.), an extremely high frequency range (e.g., 30-300 ghz, etc.), greater than 300 ghz (e.g., infrared, optical, gamma rays, x-rays, etc.) etc. According to various exemplary embodiments, DSAS 11 and any of its varying components may be of any number of wireless communication technologies (e.g., microwave, wireless Ian, wireless wan, radar systems, cellular systems, television, Bluetooth, mobile, ground-to-air, air-to-air, two way radio, FM radio, shortwave, amateur, AM radio, navigation systems, time signal systems, avalanche beacons, submarine communications, healthcare monitors, mine systems, etc.). According to various exemplary embodiments, DSAS 11 may be implemented to, with, and/or by any wireless technology of the past, present or future capable of enabling wireless communications.

It is important to note that the construction and arrangement of the distributed spectrum analyzer as shown in the various exemplary embodiments is illustrative only. Although only a few embodiments of the present inventions have been described in detail in this disclosure, those skilled in the art who review this disclosure will readily appreciate that many modifications are possible (e.g., variations in sizes, dimensions, structures, shapes and proportions of the various elements, values of parameters, mounting arrangements, technologies, use of materials, colors, orientations, etc.) without materially departing from the novel teachings and advantages of the subject matter recited in the claims. For example, elements shown as integrally formed may be constructed of multiple parts or elements (e.g., RF-enabled devices 13, controller system 14, etc.), the position of elements may be reversed or otherwise varied (e.g., RF-enabled devices 13, controller system 14, etc.), and the nature or number of discrete elements or positions may be altered or varied (e.g., RF-enabled devices 13, controller system 14, etc.). Accordingly, all such modifications are intended to be included within the scope of the present invention as defined in the appended claims. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present inventions as expressed in the appended claims.

What is claimed is:

1. A method of managing the radio frequency environment of a building zone using a plurality of radio frequency enabled building management devices distributed around the building zone, comprising:
interrupting a radio frequency enabled building management device from the device's primary building management function when a measuring event occurs;
measuring radio frequency information of the building zone using the interrupted radio frequency enabled building management device;
sending the measured radio frequency information from the radio frequency enabled building management device to a controller system;
storing the measured radio frequency information in a database of the controller system; and
repeating the interrupting, measuring, sending, and storing steps for a plurality of radio frequency enabled building management devices.

2. The method of claim 1, further comprising suggesting operating parameters to a user for two different wireless systems located in or around the building zone based on the measured radio frequency information.

3. The method of claim 1, further comprising alerting a user when a potential conflict between two different wireless systems is detected.

4. The method of claim 3, further comprising recommending a course of action to a user regarding configuration of the two different wireless systems.

5. The method of claim 1, further comprising displaying a map of radio frequency energy in or around the building zone.

6. The method of claim 5, wherein the map is a graphical user interface map.

7. The method of claim 1, further comprising displaying the measured radio frequency information to a user.

8. The method of claim 1, further comprising processing the radio frequency information to create a report of the radio frequency environment of the building zone.

9. The method of claim 1, further comprising defining radio frequency ranges or channel ranges in or around the building zone based on the measured radio frequency information.

10. The method of claim 9, further comprising presenting the defined ranges to a user.

11. The method of claim 9, further comprising using the defined ranges to suggest operating parameters for a wireless system.

12. The method of claim 9, further comprising using the defined ranges to suggest operating parameters for at least two wireless systems.

13. The method of claim 9, further comprising developing an action strategy based upon the defined ranges.

14. The method of claim 1, further comprising displaying a graph of the measured radio frequency information.

15. The method of claim 1, further comprising developing a list of alternative channels for a wireless system.

16. The method of claim 1, further comprising scheduling a channel switch based on the measured radio frequency information.

17. The method of claim 1, wherein measuring radio frequency information of a building zone using the radio frequency enabled building management device includes measuring over a frequency range greater than the operating range of the device when the device is operating in its primary building management function.

18. A distributed spectrum analyzer for a building automation system comprising:
a plurality of radio frequency enabled building management devices distributed around a building zone, each of the plurality of devices capable of measuring radio frequency information in the building zone; and
a controller system configured to collect and analyze the measured radio frequency information, wherein the controller system maintains a database of collected measured radio frequency information.

19. The system of claim 18, wherein the controller system is further configured to generate a graphical user interface map based on the database of collected measured radio frequency information.

20. The system of claim 18, wherein the controller system is further configured to generate a report containing radio frequency information about at least two different wireless systems.
